(19) United States
(12) Patent Application Publication
(10) Pub. No.: US 2026/0088539 A1
(43) Pub. Date: Mar. 26, 2026

(54) EASY-LOCK CONNECTOR ASSEMBLY

(71) Applicant: P-TWO INDUSTRIES INC., Taoyuan City (TW)

(72) Inventors: Chun-Wei Chang, Taoyuan City (TW); Chih-Wei Huang, Taoyuan City (TW)

(21) Appl. No.: 19/292,317

(22) Filed: Aug. 6, 2025

(30) Foreign Application Priority Data
Sep. 20, 2024 (TW) 113135896

(51) Int. Cl. H01R 12/77

(52) U.S. Cl. CPC H01R 12/774

(57) ABSTRACT

An easy-lock connector assembly is provided, which includes a first connector and a second connector. The first connector includes a first insulating housing having an accommodation space and a first metal shell, and the second connector can be inserted into the accommodation space in a first direction. The second connector includes a second insulating housing, a second metal shell and an operated member. The second metal shell is formed with a locking arm which is movable between a latched position and an unlatched position in a second direction perpendicular to the first direction and normally biased to the latched position. An operated member is movably retained by the second insulating housing and is configured to push the locking arm and bias the locking arm away from the latched position. As such, an easy-lock connector assembly with good operability and high reliability is achieved.

### CROSS-REFERENCES TO RELATED APPLICATIONS

This application claims the benefit of priority to Taiwanese Patent Application No. 113135896 filed on Sep. 20, 2024, which is hereby incorporated by reference in its entirety.

### BACKGROUND OF THE INVENTION

### Field of the Invention

The present invention relates to an easy-lock connector assembly, and more particularly to an easy-lock connector assembly having excellent operability and high reliability.

### Descriptions of the Related Art

Taiwanese Utility Model Patent No. M644042U (Patent Document 1) discloses a connector for a flexible flat cable. The connector disclosed in Patent Document 1 has an actuator pivoted on an insulating housing, and the lock on the flexible flat cable (FFC) is released by pressing the body of the actuator and pivotably operating the actuator. However, this actuator has a certain thickness, making it difficult to achieve a low-profile connector.

Taiwanese Utility Model Patent No. M591717U (Patent Document 2) discloses a connector for a flexible flat cable. Patent Document 2 describes a connector housing functioning as a plug which is mounted on the insertion end of the flexible flat cable. This configuration allows the mating direction of the flexible flat cable with the easy-lock connector to be changed, facilitating automated insertion of the flexible flat cable into the easy-lock connector. Additionally, it enhances the operability and protection of the flexible flat cable. However, in the easy-lock connector disclosed in Patent Document 2, the flexible flat cable can only be released by simultaneously operating two separate locking members, resulting in poor operability for releasing the flexible flat cable. Since the operated portions of the locking members are positioned on the same side as the flexible flat cable, the release operation may be hindered by the presence of the flexible flat cable. In addition, the locking members extend in a direction parallel to the longitudinal direction of the flexible flat cable, and thus the size of the connector in the longitudinal direction of the flexible flat cable is increased. On the other hand, the occupied area of the connector on the circuit board is also increased.

### SUMMARY OF THE INVENTION

One object of the present invention is to provide an easy-lock connector assembly which has excellent operability and high reliability.

Another object of the present invention is to provide an easy-lock connector assembly having a low profile and suitable for a compact or thin electronic machine.

A further object of the present invention is to provide an easy-lock connector assembly capable of facilitating automated assembly.

According to an aspect of the present invention, an easy-lock connector assembly is provided, which comprises a first connector and a second connector which is matable with the first connector in a first direction;

wherein the first connector comprises:

a first insulating housing, having an accommodation space, wherein the second connector is to be inserted into the accommodation space in the first direction in such a manner that at least a portion of the second connector is received in the accommodation space;

a plurality of contacts held by the first insulating housing, the plurality of contacts being arranged in a second direction perpendicular to the first direction, each contact including a contact portion extending into the accommodation space and a connection terminal portion opposite to the contact portion; and

a first metal shell covering a portion of the first insulating housing, the first metal shell having two first engagement portions opposite to each other in the second direction;

wherein the second connector comprises:

a second insulating housing;

a second metal shell covering a portion of the second insulating housing, the second metal shell having two locking arms at two opposite sides of the second metal shell in the second direction, each locking arm being oriented in the first direction, each locking arm being movable in the second direction between a latched position and an unlatched position and normally biased to the latched position, each locking arm having a second engagement portion such that when the second connector is mated with the first connector, the second engagement portions of the two locking arms are respectively engaged with the two first engagement portions, preventing the second connector from being detached from the first connector; and

two operated members which are held by the second insulating housing in such a manner that the two operated members are movable in the second direction, each operated member being configured to push a respective one of the locking arms in the second direction, such that by operating the two operated members, the two locking arms are biased away from the latched position in the second direction, allowing the second connector to be removed from the first connector.

According to the easy-lock connector assembly of the present invention, the second insulating housing has two guide posts extending from a bottom surface of the second insulating housing in the first direction, the guide posts being provided for guiding insertion of the second connector into the accommodation space during a process of mating the second connector with the first connector.

According to the easy-lock connector assembly of the present invention, each guide post has a chamfered end.

According to the easy-lock connector assembly of the present invention, the first insulating housing has two guide post holes for respectively receiving the two guide posts.

According to the easy-lock connector assembly of the present invention, the two locking arms are respectively and partially sheltered by the two guide posts.

According to the easy-lock connector assembly of the present invention, each locking arm is U-shaped.

According to the easy-lock connector assembly of the present invention, each locking arm is L-shaped.

According to the easy-lock connector assembly of the present invention, the second metal shell comprises an upper shell and a lower shell, the upper shell is disposed on an upper side of the second insulating housing, and the lower shell is disposed on a lower side of the second insulating housing; the second connector further comprises a flat connection object including a head portion and a plurality of electrode portions formed on the head portion, wherein the head portion of the flat connection object is accommodated in a space defined by the second insulating housing and the lower shell, and the plurality of electrode portions are exposed from the lower shell such that when the second connector is mated with the first connector, the plurality of electrode portions are brought into electrical contact with the plurality of contacts of the first connector respectively.

According to the easy-lock connector assembly of the present invention, the two operated members are respectively disposed at two end portions of the second insulating housing in the second direction, each operated member comprises a body portion and a rail portion extending from the body portion in the second direction, wherein each of the two end portions of the second insulating housing is formed with a guide channel configured to receive the rail portion.

According to the easy-lock connector assembly of the present invention, the rail portion has a protrusion configured to prevent the rail portion from being detached from the guide channel.

The above and other objects and advantages of the present invention will become apparent from the accompanying drawings and the following detailed description.

### BRIEF DESCRIPTION OF THE DRAWINGS

FIG. 1 is a perspective view of the easy-lock connector assembly in a mated state according to the first embodiment of the present invention.

FIG. 2 is a perspective view of the easy-lock connector assembly in an unmated state according to the first embodiment of the present invention.

FIG. 3 is a perspective view of the receptacle connector according to the first embodiment of the present invention.

FIG. 4 is an exploded perspective view of the receptacle connector according to the first embodiment of the present invention.

FIG. 5 is a perspective view of a first insulating housing of the receptacle connector according to the first embodiment of the present invention.

FIG. 6 is a perspective view of a plurality of contacts of the receptacle connector according to the first embodiment of the present invention.

FIG. 7 is a perspective view of a first metal shell of the receptacle connector according to the first embodiment of the present invention.

FIG. 8 is a perspective view of the plug connector according to the first embodiment of the present invention.

FIG. 9 is another perspective view of the plug connector according to the first embodiment of the present invention.

FIG. 10 is an exploded perspective view of the plug connector according to the first embodiment of the present invention.

FIG. 11 is a perspective view of a second insulating housing of the plug connector according to the first embodiment of the present invention.

FIG. 12 is a perspective view of an upper shell of the plug connector according to the first embodiment of the present invention.

FIG. 13 is a front view of the plug connector according to the first embodiment of the present invention, wherein the second insulating housing is not shown.

FIG. 14 is a top view of the easy-lock connector assembly in a locked state according to the first embodiment of the present invention.

FIG. 15 is a front view of the easy-lock connector assembly in a locked state according to the first embodiment of the present invention.

FIG. 16 is a sectional view taken along the line AA in FIG. 14.

FIG. 17 is a sectional view taken along the line BB in FIG. 15.

FIG. 18 is a top view of the easy-lock connector assembly in an unlocked state according to the first embodiment of the present invention.

FIG. 19 is a sectional view taken along the line CC in FIG. 18.

FIG. 20 is a perspective view of the easy-lock connector assembly in an unmated state according to the second embodiment of the present invention.

FIG. 21 is an exploded perspective view of the receptacle connector according to the second embodiment of the present invention.

FIG. 22 is an exploded perspective view of the plug connector according to the second embodiment of the present invention.

FIG. 23 is a perspective view of a second insulating housing of the plug connector according to the second embodiment of the present invention.

FIG. 24 is an upper shell of the plug connector according to the second embodiment of the present invention.

FIG. 25 is a front view of the plug connector according to the second embodiment of the present invention, wherein the second insulating housing is not shown.

FIG. 26 is a top view of the easy-lock connector assembly in a locked state according to the second embodiment of the present invention.

FIG. 27 is a front view of the easy-lock connector assembly in a locked state according to the second embodiment of the present invention.

FIG. 28 is a sectional view taken along the line DD in FIG. 26.

FIG. 29 is a sectional view taken along the line EE in FIG. 27.

FIG. 30 is a top view of the easy-lock connector assembly in an unlocked state according to the second embodiment of the present invention.

FIG. 31 is a sectional view taken along the line FF in FIG. 30.

### DETAILED DESCRIPTION OF THE PREFERRED EMBODIMENT

The easy-lock connector assembly according to the embodiments of the present invention will be described with reference to the drawings. In the drawings, the same components or components with similar functions are denoted by the same reference numerals. The drawings are not necessarily drawn to scale.

### The First Embodiment

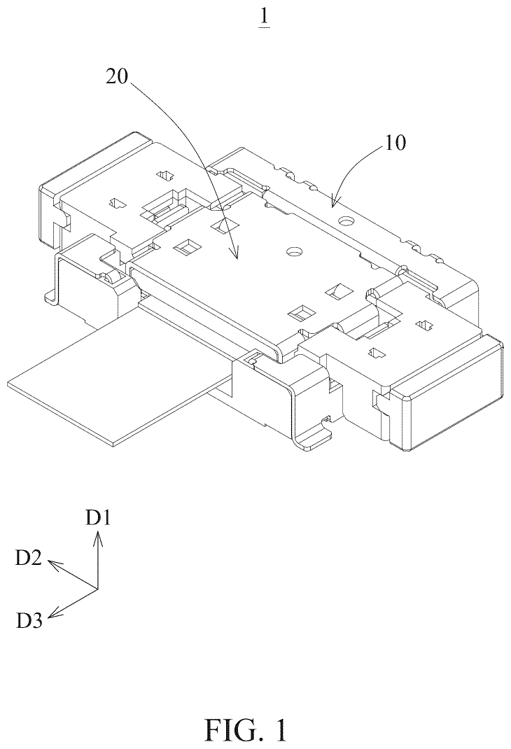

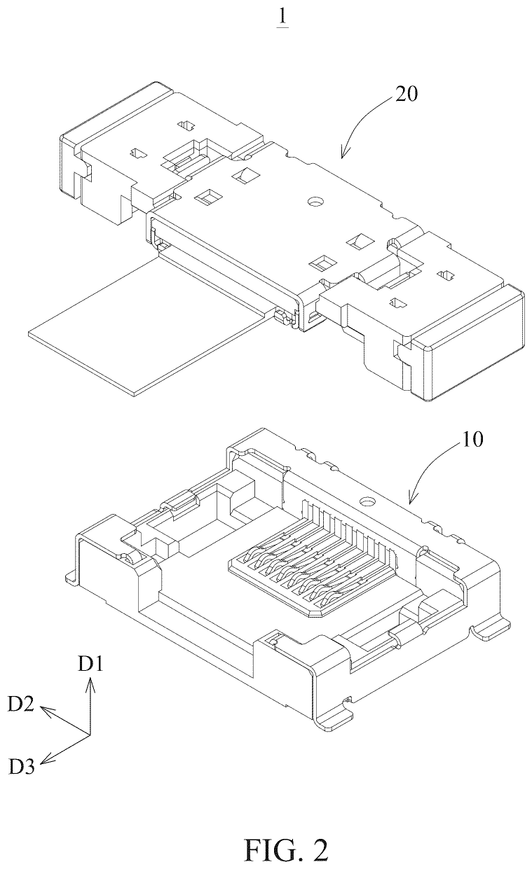

The easy-lock connector assembly according to the first embodiment of the present invention is described by referring to FIGS. 1 and 2. FIG. 1 is a perspective view of the easy-lock connector assembly in a mated state according to the first embodiment of the present invention, and FIG. 2 is a perspective view of the easy-lock connector assembly in an unmated state according to the first embodiment of the present invention. The easy-lock connector assembly is entirely denoted by the reference numeral 1. The easy-lock connector assembly 1 comprises a receptacle connector 10 as a first connector and a plug connector 20 as a second connector. The plug connector 20 can be mated with the receptacle connector 10 in a first direction D1.

In this embodiment, the receptacle connector 10 is a board-mounted connector, while the plug connector 20 is formed by attaching a connector housing (i.e., a second insulating housing) and a connector shell (i.e., a second metal shell) to a head portion of a flat connection object such as a flexible flat cable (FFC) or a flexible printed circuit (FPC). In the description, the assembly composed of the connector housing (i.e., the second insulating housing), the connector shell (i.e., the second metal shell) and the flat connection object is referred to as the second connector or the plug connector.

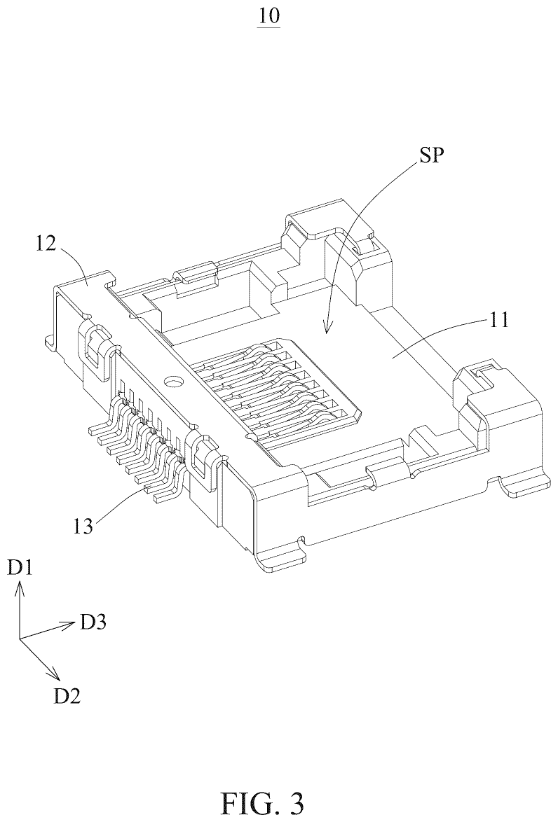

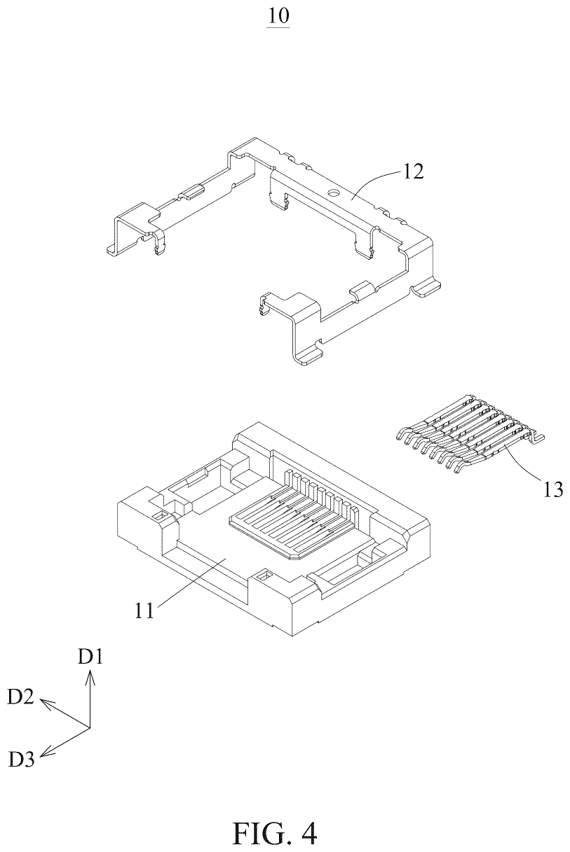

The receptacle connector 10 of the first embodiment of the present invention is described by referring to FIGS. 3 and 4. FIG. 3 is a perspective view of the receptacle connector 10 according to the first embodiment of the present invention, and FIG. 4 is an exploded perspective view of the receptacle connector 10 according to the first embodiment of the present invention. The receptacle connector 10 includes a first insulating housing 11, a first metal shell 12 and a plurality of contacts 13.

The plug connector 20 can be inserted into the receptacle connector 10 in the first direction D1 (i.e., the height direction or the mating direction). The flat connection object forming a part of the plug connector 20 may be a flexible flat cable (FFC) or a flexible printed circuit (FPC), but the present invention is not limited thereto. The flat connection object may be a card board. The flat connection object includes a plurality of electrode portions formed on the head portion of the flat connecting object. The plug connector 20 may be a wire-end connector in a wire-to-board connector assembly.

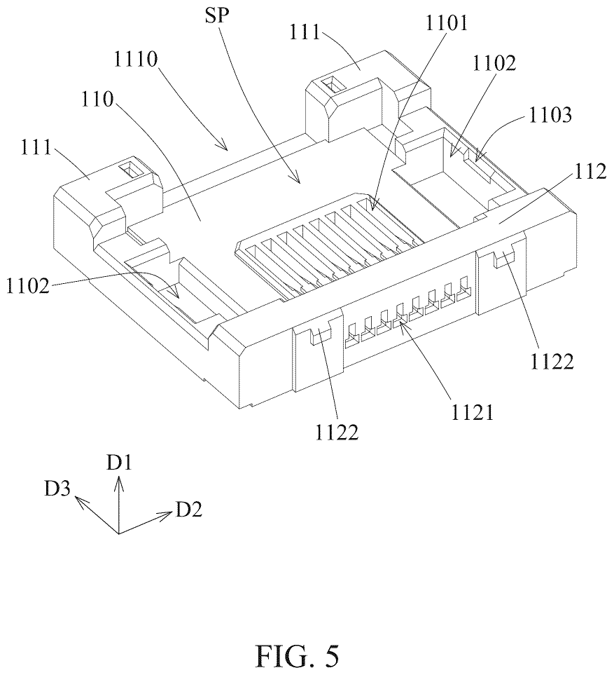

FIG. 5 is a perspective view of the first insulating housing 11. The configuration of the first insulating housing 11 is described by referring to FIG. 5. The first insulating housing 11 is made of insulating synthetic resin or polymer material. The first insulating housing 11 includes a flat rectangular body 110 and a peripheral wall formed on the edge of the flat rectangular body 110. The flat rectangular body 110 and the peripheral wall define an accommodation space SP. The peripheral wall consists of a front wall portion 111 and a rear wall portion 112 opposite to the front wall portion 111.

The flat rectangular body 110 is formed with a plurality of contact grooves 1101. The contact grooves 1101 are arranged in a second direction D2 (i.e., the width direction) perpendicular to the first direction D1 and are spaced from each other. The flat rectangular body 110 has two guide post openings 1102 spaced from each other in the second direction D2. The upper edge of each guide post opening 1102 is chamfered. A recess 1103 is formed on the upper edge of the inner surface of each guide post opening 1102.

The front wall portion 111 is formed with a notch 1110. The notch 1110 is provided for preventing interference between the front wall portion 111 and the flat connection object.

The rear wall portion 112 is formed with a plurality of contact holding holes 1121. Each contact holding hole 1121 is communicated with a respective contact groove 1101. The rear wall portion 112 is further formed with two protrusions 1122 for attachment of the first metal shell 12 to the first insulating housing 11.

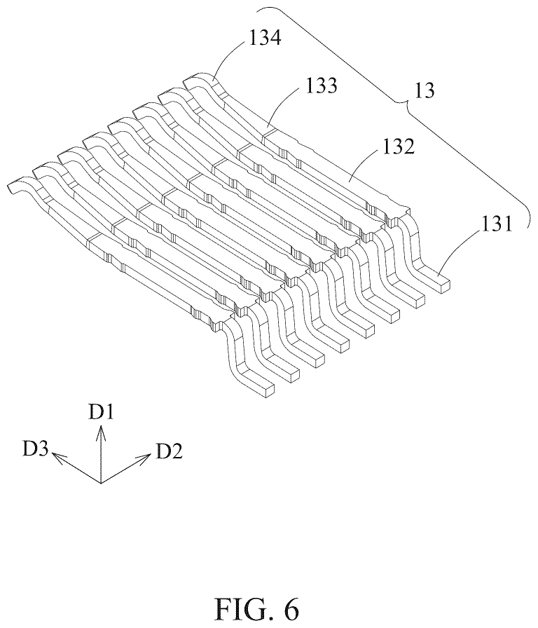

FIG. 6 is a perspective view of the plurality of contacts 13. The contacts 13 are arranged in one row in the second direction D2 and are held by the first insulating housing 11. Each contact 13 is made of copper or a copper alloy. Each contact 13 includes a connection terminal portion 131, a held portion 132, a contact arm 133 and a contact portion 134. The contact arm 133 extends from one end of the held portion 132, while the connection terminal portion 131 extends from the other end of the held portion 132. The held portion 132 is formed with a barb structure and is inserted into the contact holding hole 1121 in an interference-fit manner. The contact portion 134 is formed on a distant end of the contact arm 133. Each contact arm 133 extends substantially in a third direction D3 (i.e., the front-rear direction) perpendicular to the first direction D1 and the second direction D2 in a respective contact groove 1101 and extends into the accommodation space SP, so that the contact portion 134 is brought into contact with the electrode portion formed on the flat connection object. The connection terminal portion 131 protrudes from the first insulating housing 11 and can be soldered to the solder pad formed on a circuit board by using surface mount technology (SMT).

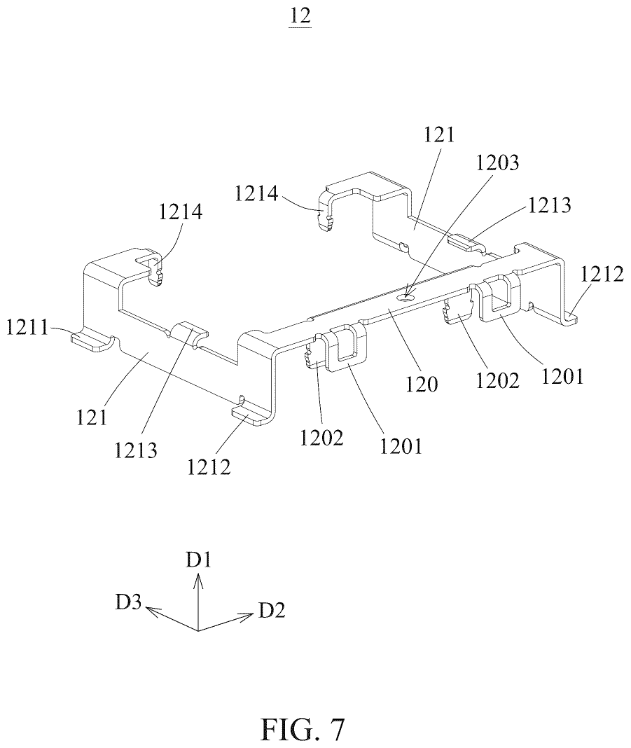

FIG. 7 is a perspective view of the first metal shell 12. The first metal shell 12 is formed by stamping and bending a metal plate (e.g., a plate made of stainless steel or phosphor bronze). The first metal shell 12 is configured to have a generally U-shape when viewed from the first direction D1. The first metal shell 12 includes two lateral shell portions 121 and a connecting portion 120 which connects the two lateral shell portions 121.

The lower edge of each lateral shell portion 121 includes a first soldered portion 1211 adjacent to the front end of the lateral shell portion 121 and a second soldered portion 1212 adjacent to the rear end of the lateral shell portion 121. The first soldered portion 1211 and the second soldered portion 1212 can be soldered to the solder pads formed on a circuit board by using surface mount technology (SMT). In this manner, the receptacle connector 10 can be firmly mounted on the circuit board. The upper edge of each lateral shell portion 121 has a stopper portion 1213, which serves as a first engagement portion, located centrally. The distant end of each lateral shell portion 121 is formed with a held portion 1214. The held portion 1214 is formed with a barb structure and is inserted into a holding hole formed in the first insulating housing 11 in an interference-fit manner. In this way, the distant end of the lateral shell portion 121 is attached to the first insulating housing 11.

The rear edge of the connecting portion 120 is formed with an engaging portion 1201 for engagement with the protrusion 1122 formed on the rear wall portion 112 of the first insulating housing 11. The inner edge of the connecting portion 120 is formed with a held portion 1202. The held portion 1202 is formed with a barb structure and is inserted into a holding hole formed in the first insulating housing 11 in an interference-fit manner. In this way, the connecting portion 120 is attached to the first insulating housing 11. Furthermore, by engagement of the engaging portion 1201 with the protrusion 1122, the first metal shell 12 is prevented from being detached from the first insulating housing 11.

The connecting portion 120 is formed with an alignment hole 1203. When a robotic arm picks up the plug connector 20 and aligns it with the accommodation space SP of the receptacle connector 10, the alignment hole 1203 serves as an alignment mark recognizable by a machine vision system.

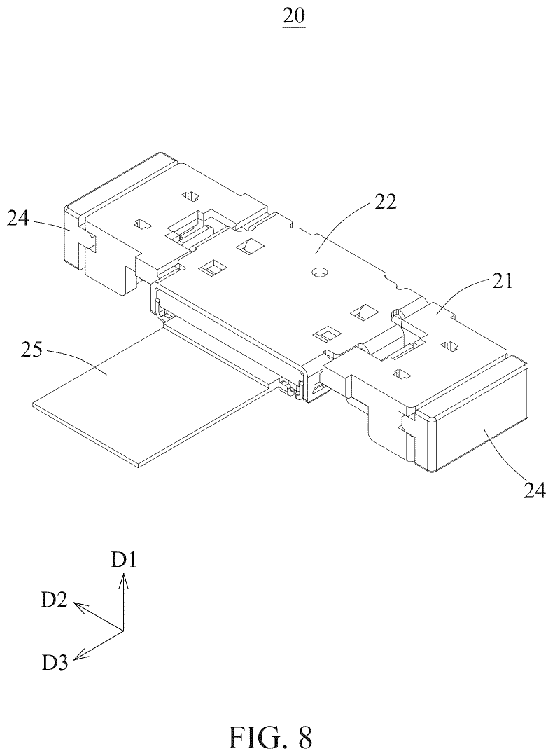

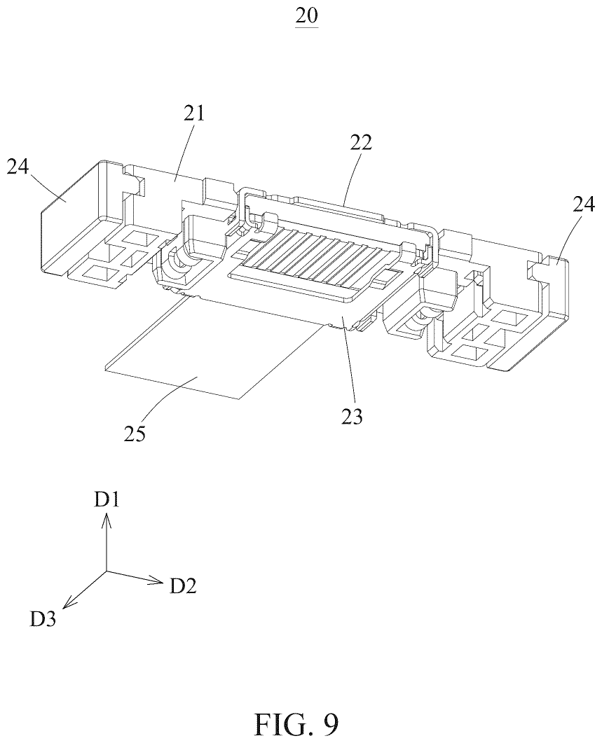

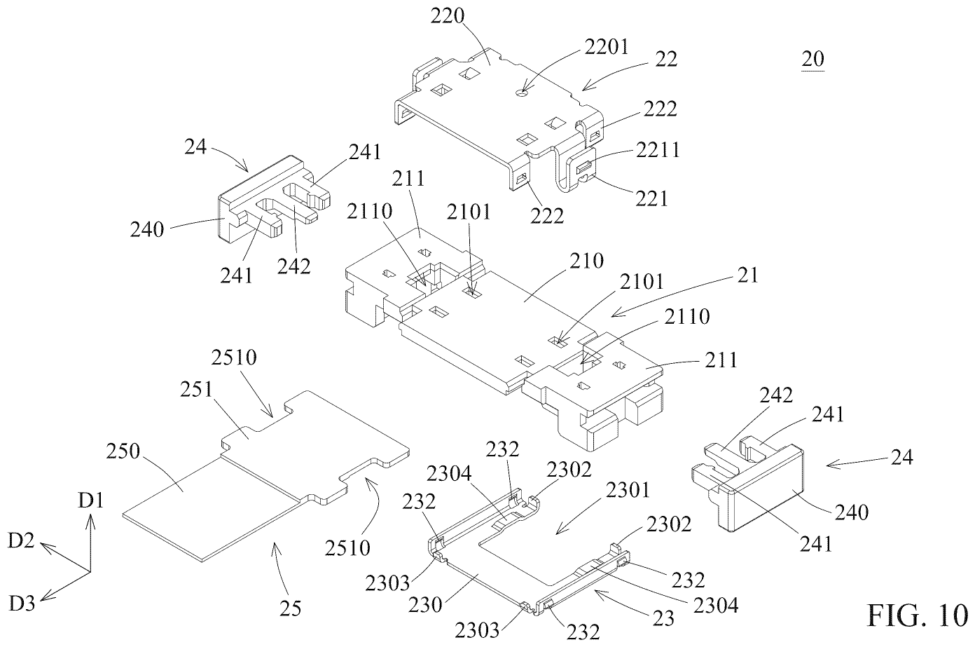

The plug connector 20 of the first embodiment of the present invention is described by referring to FIGS. 8, 9 and 10. FIG. 8 is a perspective view of the plug connector 20 according to the first embodiment of the present invention, FIG. 9 is another perspective view of the plug connector 20 according to the first embodiment of the present invention, and FIG. 10 is an exploded perspective view of the plug connector 20 according to the first embodiment of the present invention. The plug connector 20 includes a second insulating housing 21, a second metal shell, two operated members 24 and a flat connection object 25. The second metal shell is composed of an upper shell 22 and a lower shell 23.

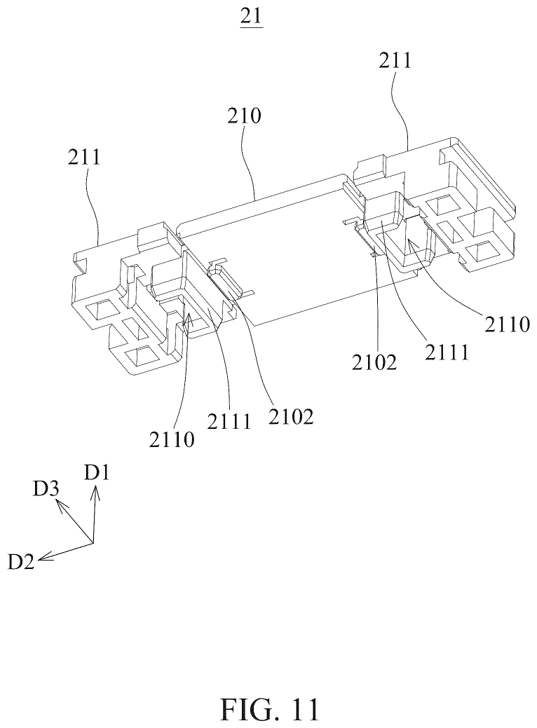

The second insulating housing 21 is described by referring to FIGS. 10 and 11. FIG. 11 is a perspective view of the second insulating housing 21. The second insulating housing 21 is made of insulating synthetic resin or polymer material. The second insulating housing 21 includes a flat rectangular body 210 and two lateral portions 211 respectively located on both sides of the flat rectangular body 210 in the second direction D2. Four positioning holes 2101 are formed on the upper surface of the flat rectangular body 210 for positioning the upper shell 22. Two protrusions 2102 are formed on the lower surface of the flat rectangular body 210 for engagement with two notches 2510 (which will be described later) of the flat connection object 25. Each lateral portion 211 is formed with a receiving opening 2110 for receiving a locking arm. As shown in FIG. 11, each lateral portion 211 is further formed with a guide post 2111 extending downward in the first direction D1 from the lower surface of the lateral portion 211. The guide posts 2111 are provided for guiding the insertion of the plug connector 20 and positioning the plug connector 20.

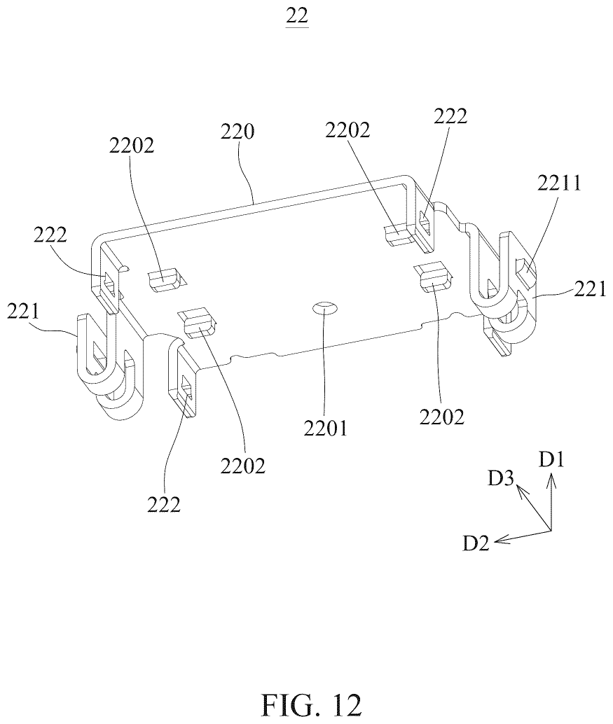

The upper shell 22 and the lower shell 23 are described by referring to FIGS. 10 and 12. FIG. 12 is a perspective view of the upper shell 22. The details of the upper shell 22 are shown in FIGS. 10 and 12, while the details of the lower shell 23 are shown in FIG. 10. The upper shell 22 and the lower shell 23 are formed by stamping and bending a metal plate (e.g., a plate made of stainless steel or phosphor bronze). The upper shell 22 is disposed on the upper side of the second insulating housing 21, while the lower shell 23 is disposed on the lower side of the second insulating housing 21.

The upper shell 22 includes a body portion 220. The body portion 220 of the upper shell 22 has a flat surface which can be adsorbed by a vacuum nozzle. The body portion 220 of the upper shell 22 is formed with an alignment hole 2201. Similar to the alignment hole 1203, the alignment hole 2201 serves as an alignment mark recognizable by a machine vision system. The body portion 220 of the upper shell 22 has two locking arms 221 formed on the two lateral edges of the body portion 220 opposite to each other in the second direction D2, and each locking arm 221 is oriented in the first direction D1. When the upper shell 22 is attached to the second insulating housing 21, the locking arms 221 are respectively positioned in the receiving holes 2110 and are partially sheltered by the guide posts 2111, while a portion of each locking arm 221 remains unsheltered by the guide posts 2111. The guide posts 2111 function to protect the locking arms 221 from being unintentionally impacted. In the first embodiment, each locking arm 221 is U-shaped. Each locking arm 221 is movable in the second direction D2 between a latched position and an unlatched position and is constantly biased toward the latched position. Each locking arm 221 is formed with a latch portion 2211 as a second engagement portion, such that when the plug connector 20 is mated with the receptacle connector 10, the latch portion 2211 (i.e., the second engagement portion) is engaged with the stopper portion 1213 (i.e., the first engagement portion) formed on the first metal shell, preventing the plug connector 20 from being detached from the receptacle connector 10. Additionally, two engaging portions 222 are formed on each lateral edge of the body portion 220 of the upper shell 22. The lower surface of the upper shell 22 is formed with four positioning tabs 2202 respectively corresponding to the four positioning holes 2101. By inserting the positioning tabs 2202 into the positioning holes 2101, movement of the upper shell 22 with respect to the second insulating housing 21 in a plane perpendicular to the first direction D1 is prevented.

The lower shell 23 includes a body portion 230. The body portion 230 has a notch 2301, through which a portion of the bottom surface of the flat connection object 25 is exposed. Two first limiting portions 2302 are formed on the front edge of the lower shell 23, and two second limiting portions 2303 are formed on the rear edge of the lower shell 23. Additionally, two protruding portions 232 are formed on each lateral edge of the lower shell 23. By engaging the protruding portions 232 with the engaging portions 222, the upper shell 22 and the lower shell 23 are securely fixed together to form the second metal shell.

The body portion 230 of the lower shell 23 is further formed with two bosses 2304 serving as gap adjusters. The bosses 2304 prevent the flat connection object 25 from wobbling up and down with respect to the second insulating housing 21 and the lower shell 23.

The flat connection object 25 is described by referring to FIG. 10. As shown in FIG. 10, the flat connection object 25 includes a head portion 251 and an extension portion 250. A notch 2510 is formed on each lateral edge of the head portion 251. In this embodiment, the flat connection object 25 is a flexible flat fable (FFC). The other end of the extension portion may be formed with another head portion. The bottom surface of the head portion 251 is formed with a plurality of electrode portions arranged in the second direction D2 adjacent to the insertion end or front edge. The head portion 251 of the flat connecting object 25 is received within a space defined by the second insulating housing 21 and the lower shell 23. These electrode portions are exposed through the notch 2301 of the lower shell 23 so that when the plug connector 20 is mated with the receptacle connector 10, these electrode portions are brought into electrical contact with the contacts 13 of the receptacle connector 10 respectively.

The plug connector 20 further includes two operated members 24. The two operated members 24 are respectively held by the two lateral portions 211 of the second insulating housing 21 in such a manner that the operated members 24 are movable in the second direction D2. Each operated member 24 is arranged to push a respective locking arm 221 inward in the second direction D2. By operating the operated members 24 (e.g., pressing the operated members 24 in the second direction D2 toward the center of the plug connector), the locking arms 221 can be biased in the second direction D2 away from the latched position so that the latch portions 2211 formed on the locking arms 221 are disengaged from the stopper portions 1213 of the first metal shell 12, thereby allowing the plug connector 20 to be removed from the receptacle connector 10.

Each operated member 24 includes a body portion 240, two rail portions 241 and a pusher portion 242. The rail portions 241 and the pusher portion 242 extend toward the center of the plug connector 20 from the body portion 240 in the second direction D2. The rail portions 241 are configured to guide the movement of the operated member 24 in the second direction D2. The pusher portion 242 is configured to push the locking arm 221 toward the center of the plug connector 20 in the second direction D2.

In other embodiments or variations, the rail portion may also function as a pusher portion, or the pusher portion may also function as a rail portion.

The first limiting portions 2302 and the second limiting portions 2303 formed on the body portion 230 of the lower shell 23 are respectively abut against the front edge and the rear edge of the head portion 251 of the flat connection object 25, preventing movement of the flat connection object 25 with respect to the second insulating housing in the third direction D3. The protrusion 2102 is abut against the inner edge of the notch 2510 of the flat connection object 25, preventing movement of the flat connection object 25 with respect to the second insulating housing in the second direction D2.

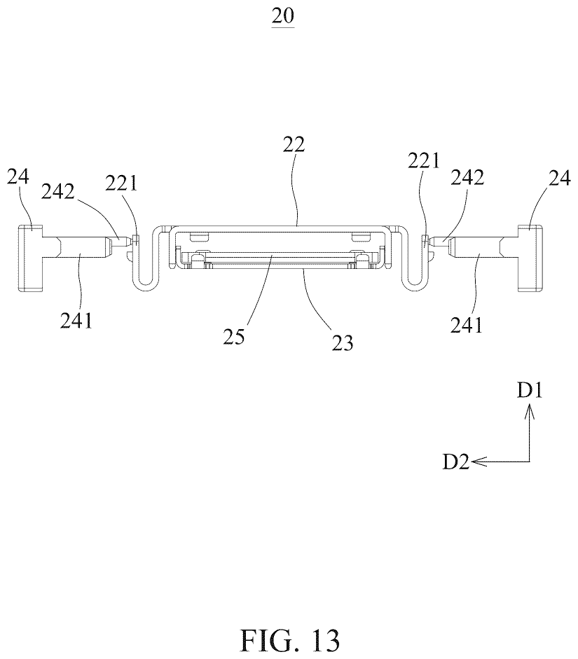

FIG. 13 is a front view of the plug connector 20 according to the first embodiment. For convenience, the second insulating housing is not shown in FIG. 13. As shown in FIG. 13, the operated members 24 are arranged to push the U-shaped locking arms 221 inward in the second direction D2 with the pusher portions 242, thereby biasing the locking arms 221 away from the latched position.

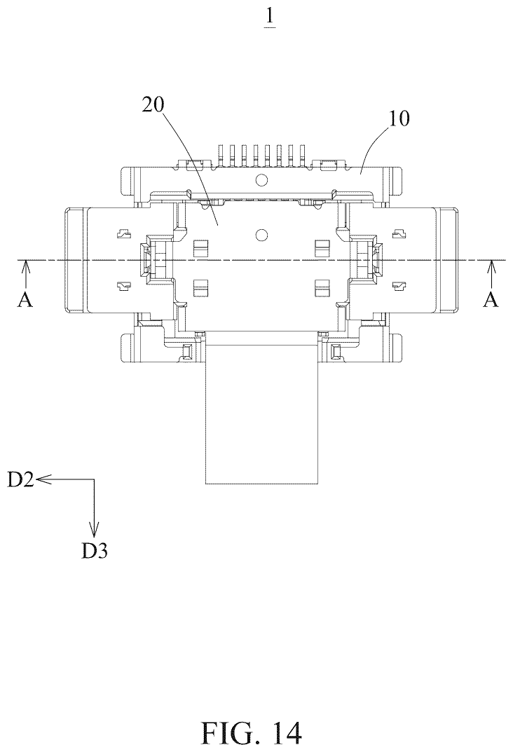

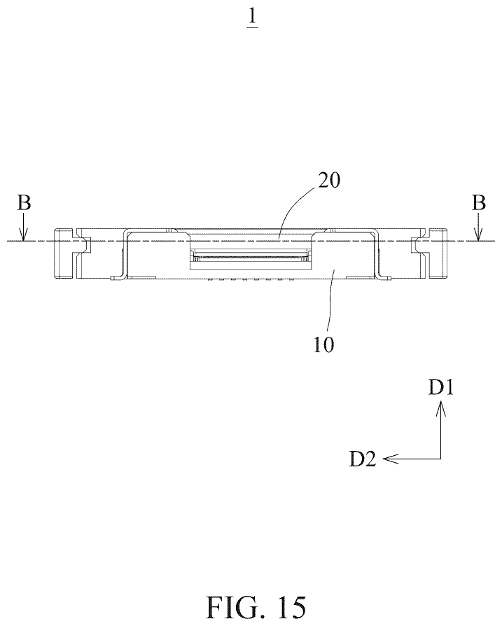

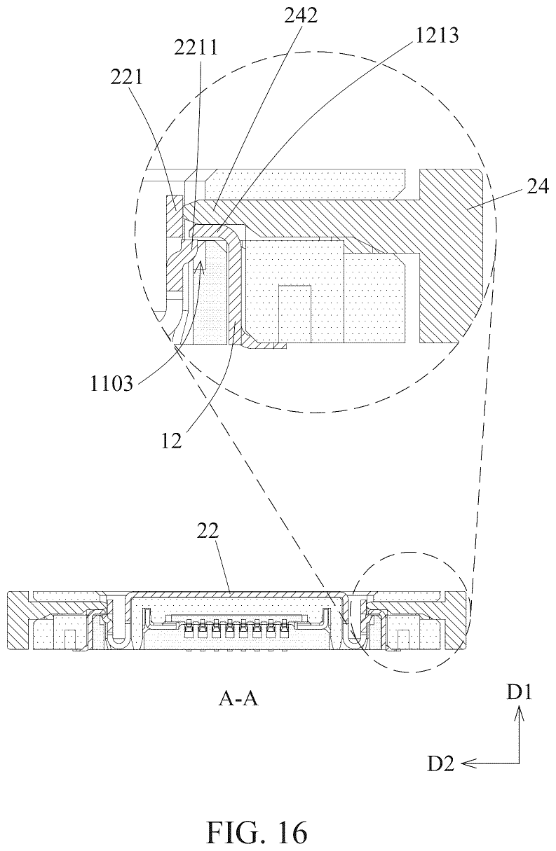

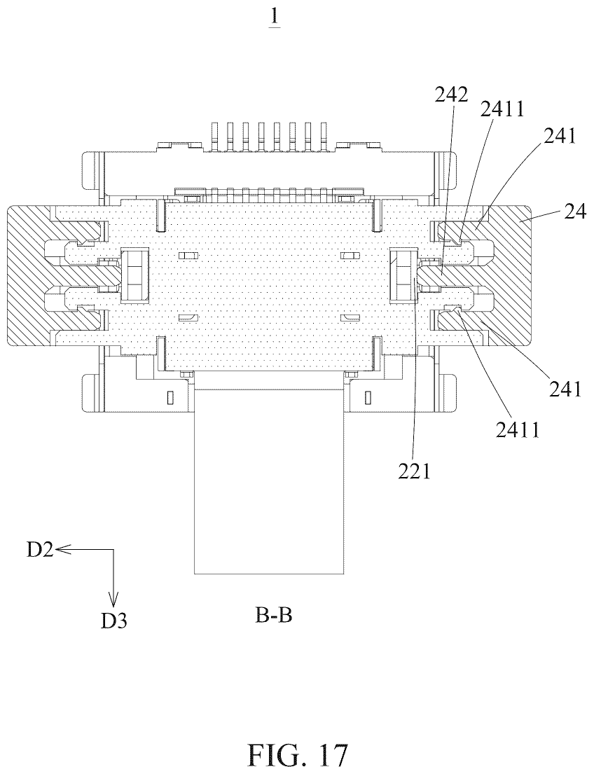

FIG. 14 is a top view of the easy-lock connector assembly 1 in a locked state according to the first embodiment, and FIG. 15 is a front view of the easy-lock connector assembly 1 in a locked state according to the first embodiment. FIG. 16 is a sectional view taken along the line AA in FIG. 14, and FIG. 17 is a sectional view taken along the line BB in FIG. 15. As shown in FIG. 16, the latch portion 2211, serving as the second engagement portion, is engaged with the stopper portion 1213, serving as the first engagement portion, preventing the plug connector 20 from being moved upward in the first direction D1 with respect to the receptacle connector. At this time, the easy-lock connector assembly 1 is in a locked state. As shown in FIG. 17, the rail portion 241 of the operated member 24 is inserted into a guide channel formed in the second insulating housing, so that the operated member 24 is held movably by the second insulating housing. The rail portion 241 has a protrusion 2411 engaged with a recess formed in the guide channel. In this way, the rail portion 241 is prevented from being detached from the guide channel. In other words, the operated member 24 is prevented from being detached from the second insulating housing. The operated member 24 is configured to move only within a limited range. Since the movement range of the operated member 24 is limited, the locking arm is prevented from being excessively pressed.

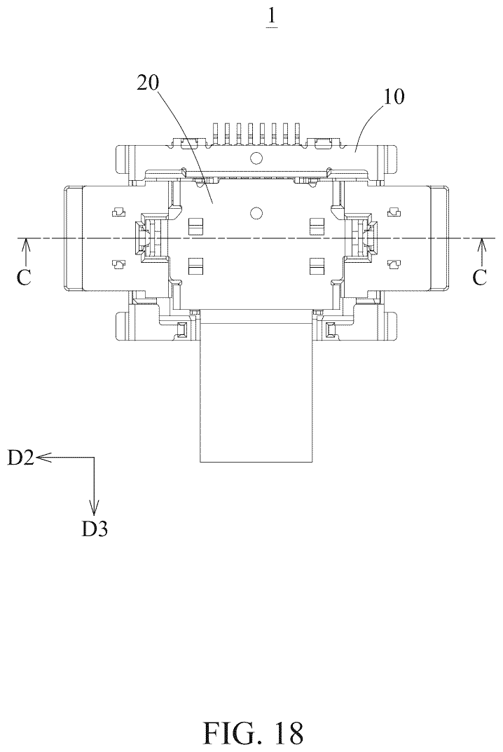

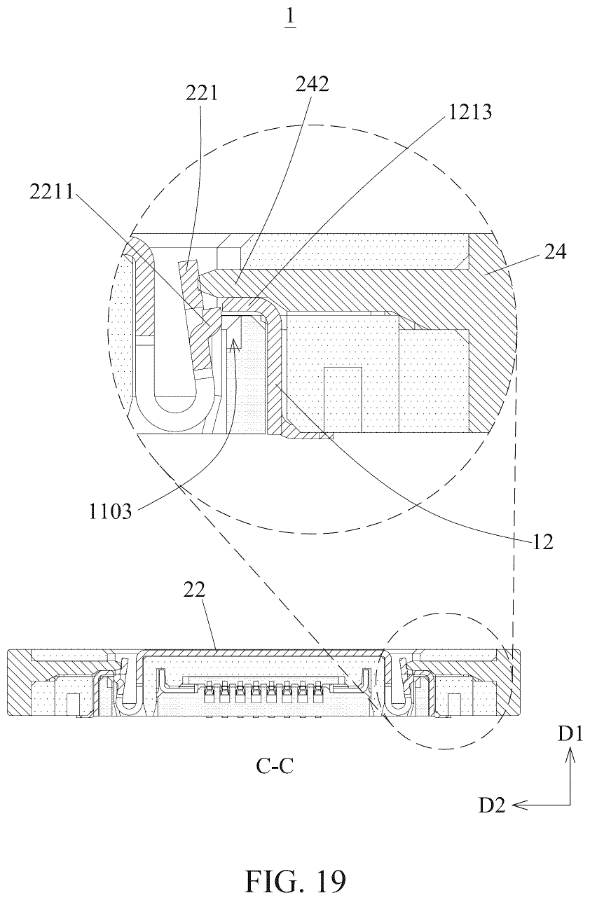

FIG. 18 is a top view of the easy-lock connector assembly 1 in an unlocked state according to the first embodiment, and FIG. 19 is a sectional view taken along the line CC in FIG. 18. As shown in FIG. 19, the locking arm 221 is pushed inward in the second direction by the pusher portion 242 of the operated member 24 so that the latch portion 2211 of the locking arm 221 is disengaged from the stopper portion 1213. At this time, the easy-lock connector assembly 1 is in an unlocked state, allowing the plug connector 20 to be removed from the receptacle connector 10.

### The Second Embodiment

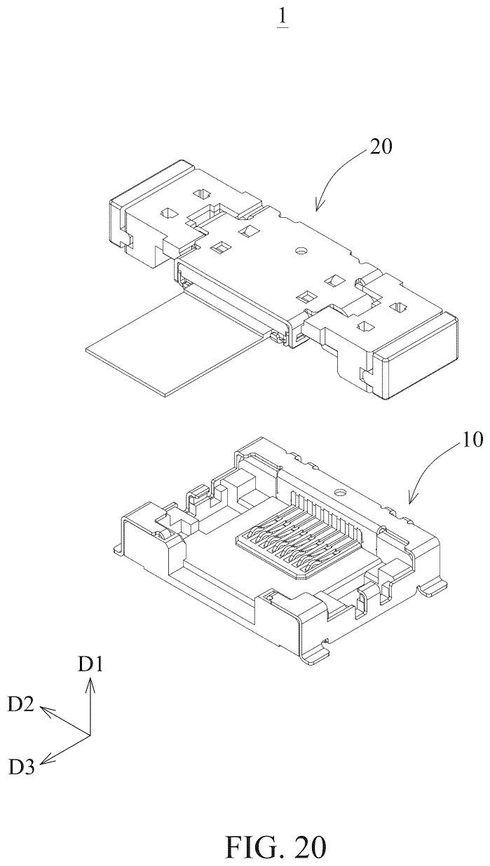

The easy-lock connector assembly according to the second embodiment of the present invention is described by referring to FIG. 20. FIG. 20 is a perspective view of the easy-lock connector assembly in an unmated state according to the second embodiment of the present invention. The same components as those in the first embodiment are denoted by the same reference numerals, and the descriptions thereof are omitted. The easy-lock connector assembly is entirely denoted by the reference numeral 1. The easy-lock connector assembly 1 includes a receptacle connector 10 as a first connector and a plug connector 20 as a second connector. The plug connector 20 can be mated with the receptacle connector 10 in the first direction D1.

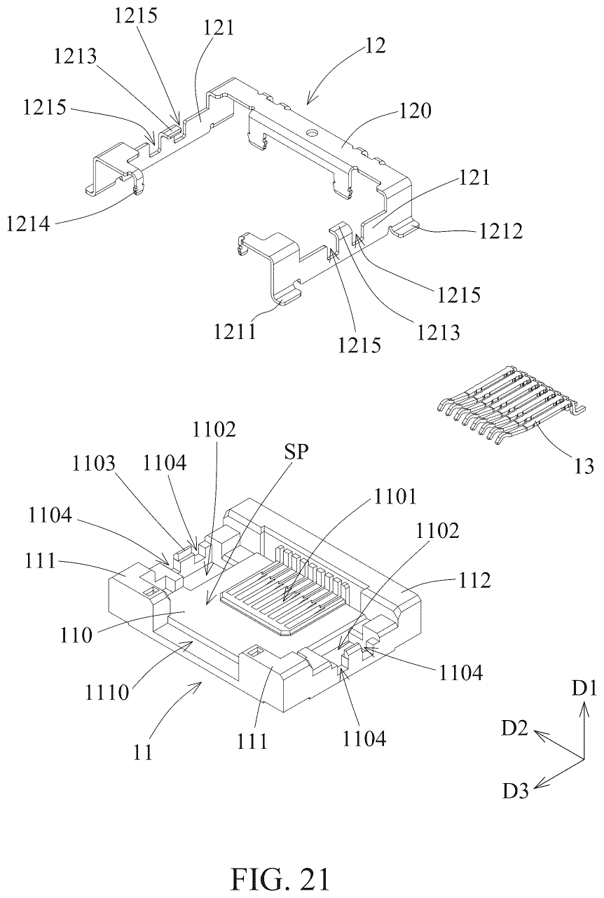

The receptacle connector 10 of the second embodiment of the present invention is described by referring to FIG. 21. FIG. 21 is an exploded perspective view of the receptacle connector according to the second embodiment of the present invention. The receptacle connector 10 includes a first insulating housing 11, a first metal shell 12 and a plurality of contacts 13. The main difference between the receptacle connector of the second embodiment and that of the first embodiment lies in that each side wall of the first insulating housing 11 is formed with two notches 1104, and each side wall of the first metal shell 12 is formed with two notches 1215. The two notches 1104 are respectively located on both sides of the recess 1103, while the two notches 1215 are respectively located on both sides of the stopper portion 1213 which serves as a first engagement portion. Rail portions of an operated member extend through the notches 1104 and 1215 to contact the locking arm 223.

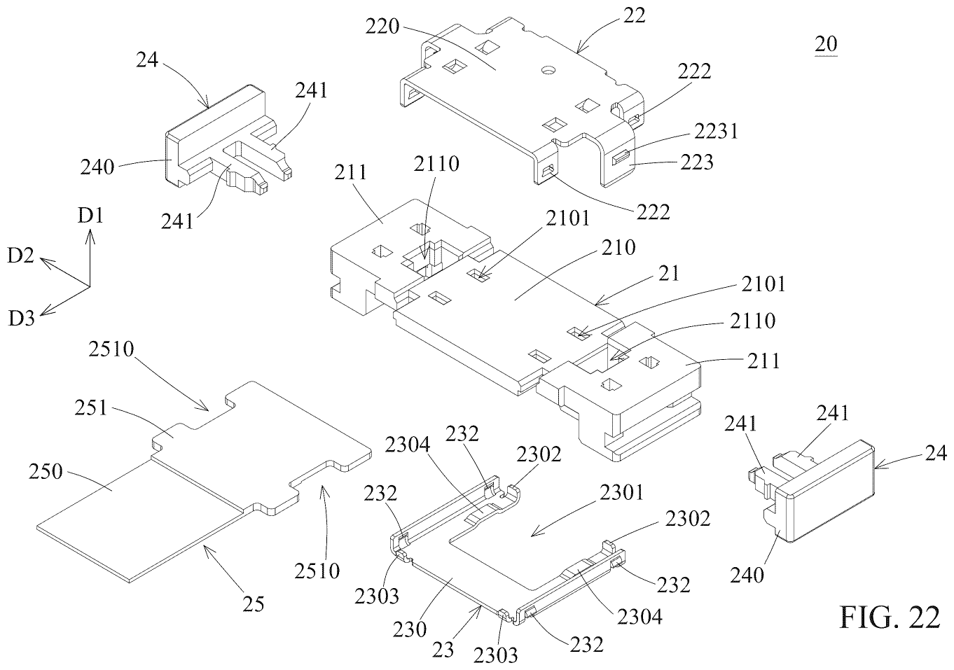

The plug connector 20 of the second embodiment of the present invention is described by referring to FIG. 22. FIG. 22 is an exploded perspective view of the plug connector according to the second embodiment of the present invention. The plug connector 20 includes a second insulating housing 21, a second metal shell, two operated members 24 and a flat connection object 25. The second metal shell is composed of an upper shell 22 and a lower shell 23. The main difference between the plug connector of the second embodiment and that of the first embodiment lies in the structure of the upper shell and the operated members. Since the lower shell and the flat connection object in the second embodiment are generally the same as those in the first embodiment, the descriptions thereof are omitted.

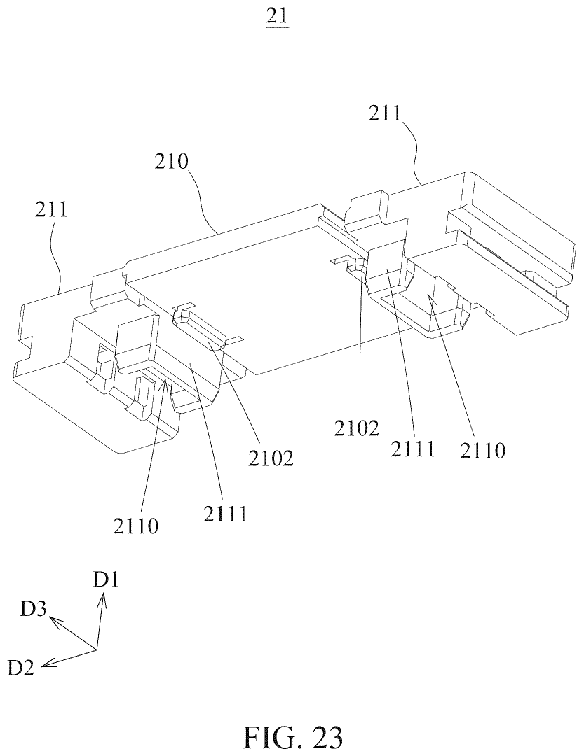

The second insulating housing 21 is described by referring to FIGS. 22 and 23. FIG. 23 is a perspective view of the second insulating housing 21. The second insulating housing 21 is made of insulating synthetic resin or polymer material. The second insulating housing 21 includes a flat rectangular body 210 and two lateral portions 211 respectively located on both sides of the flat rectangular body 210 in the second direction D2. As to the appearance, the second insulating housing of the second embodiment is not significantly different from that of the first embodiment.

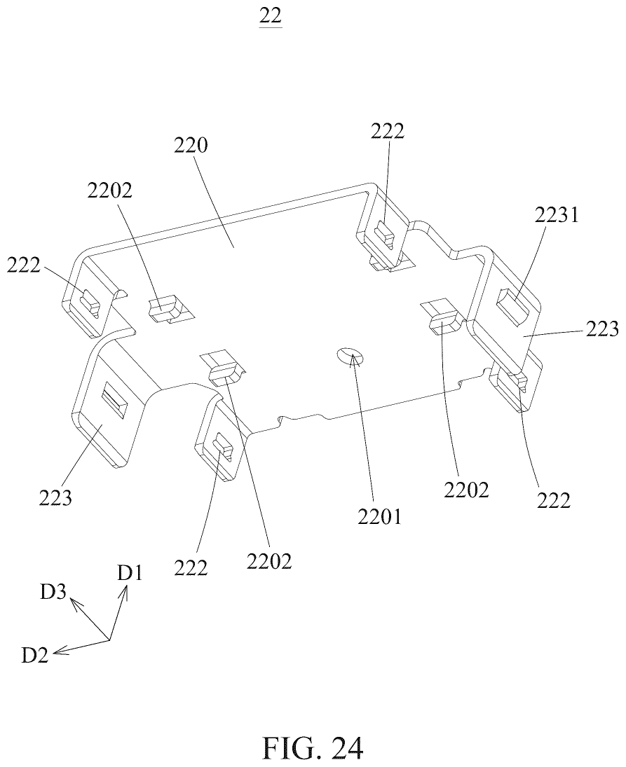

The upper shell 22 is described by referring to FIGS. 22 and 24. FIG. 24 is a perspective view of the upper shell 22. The body portion 220 of the upper shell 22 is formed with two locking arms 223, which are oriented in the first direction D1 and respectively located on both lateral edges of the body portion 220 in the second direction D2. Each locking arm 223 is movable in the second direction D2 between a latched position and an unlatched position and is normally biased toward the latched position. Each locking arm 223 is formed with a latch portion 2231 as a second engagement portion, such that when the plug connector 20 is mated with the receptacle connector 10, the latch portion 2231 (i.e., the second engagement portion) is engaged with the stopper portion 1213 (i.e., the first engagement portion) of the first metal shell, preventing the plug connector 20 from being detached from the receptacle connector 10. The main difference between the upper shell of the second embodiment and that of the first embodiment lies in the structure of the locking arms. In the second embodiment, each locking arm 223 is L-shaped.

As shown in FIG. 22, each operated member 24 includes a body portion 240 and two rail portions 241. The difference between the operated member of the second embodiment and that of the first embodiment lies in that the each rail portion 241 of the operated member in the second embodiment can function as a pusher portion. In the second embodiment, the rail portions 241 extend to the locking arm 223 so that the locking arm 223 can be pushed by the rail portions 241.

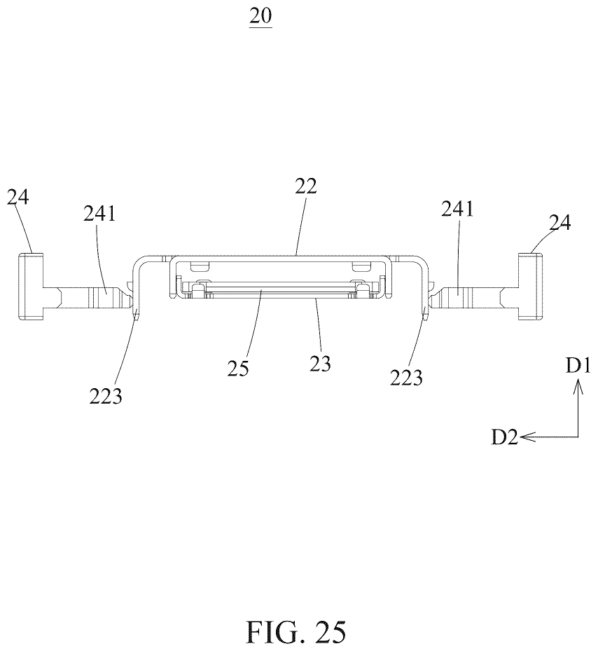

FIG. 25 is a front view of the plug connector 20 in the second embodiment. For convenience, the second insulating housing is not shown in FIG. 25. As shown in FIG. 25, the operated member 24 is arranged to push the L-shaped locking arm 223 inward in the second direction D2 with the rail portions 241, thereby biasing the locking arm 223 away from the latched position. In order to apply the pressing force to the tip of the L-shaped locking arm 223, the rail portions 241 is formed adjacent to the lower edge of the body portion of the operated member 24.

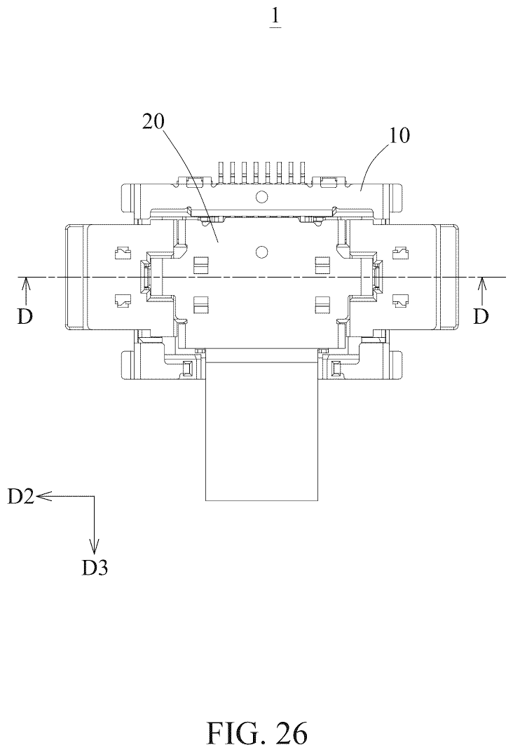

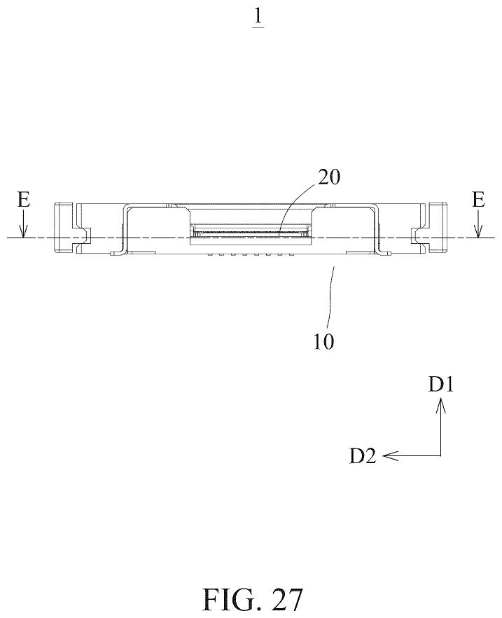

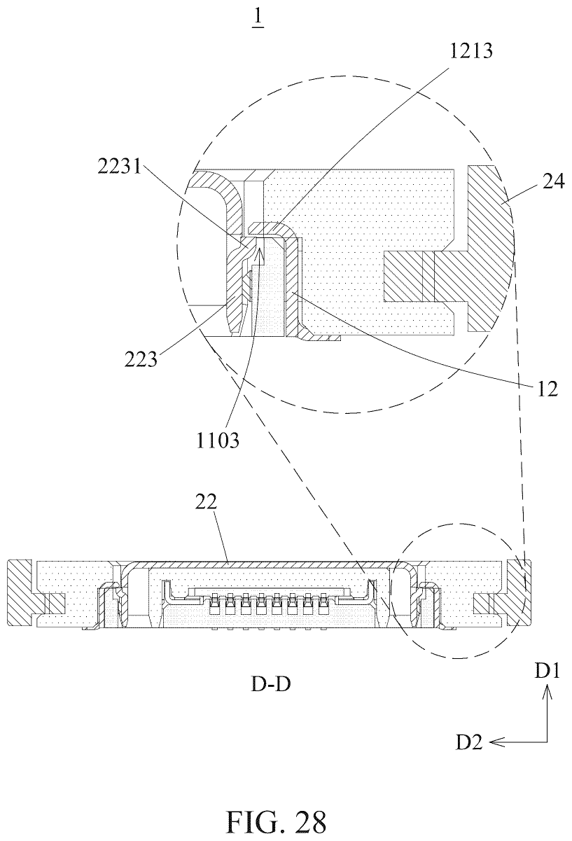

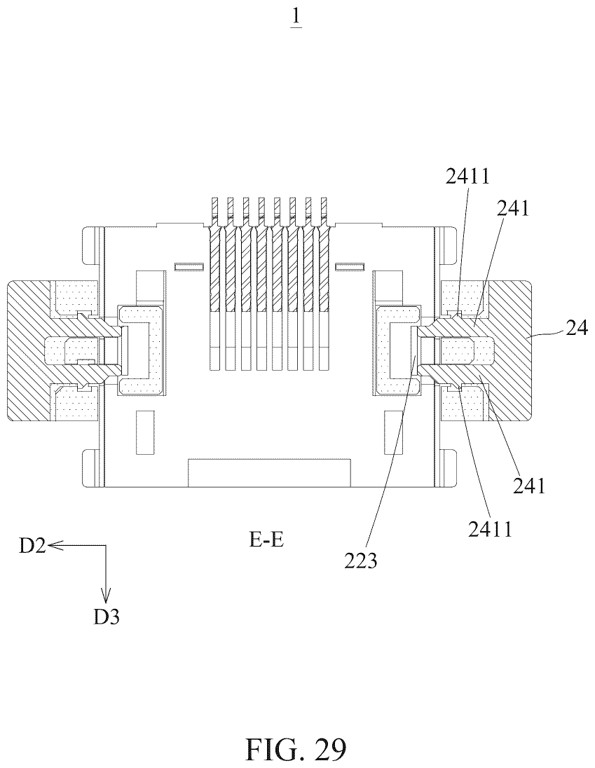

FIG. 26 is a top view of the easy-lock connector assembly 1 in a locked state according to the second embodiment, and FIG. 27 is a front view of the easy-lock connector assembly 1 in a locked state according to the second embodiment. FIG. 28 is a sectional view taken along the line DD in FIG. 26, and FIG. 29 is a sectional view taken along the line EE in FIG. 27. As shown in FIG. 28, the latch portion 2231, serving as the second engagement portion, is engaged with the stopper portion 1213, serving as the first engaging portion, so that the plug connector 20 is prevented from being moved upward in the first direction D1 with respect to the receptacle connector 10. At this time, the easy-lock connector assembly 1 is in a locked state. As shown in FIG. 29, each rail portion 241 of the operated member 24 is inserted into a guide channel formed in the second insulating housing, so that the operated member 24 is held movably by the second insulating housing. Each rail portion 241 has a protrusion 241 engaged with a recess formed in the guide channel. In this way, the rail portion 241 is prevented from being detached from the guide channel. In the second embodiment, the rail portions 241 of the operated member 24 are configured to push the L-shaped locking arm 223 inward in the second direction D2. The operated member 24 is configured to move only within a limited range, preventing the locking arm from being excessively pressed.

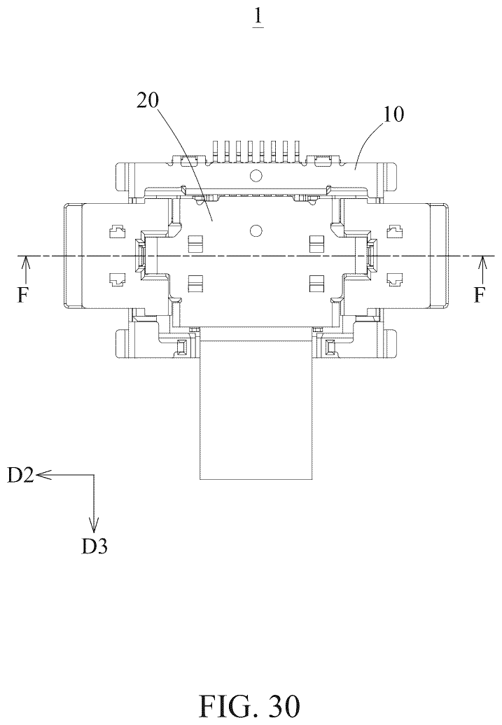

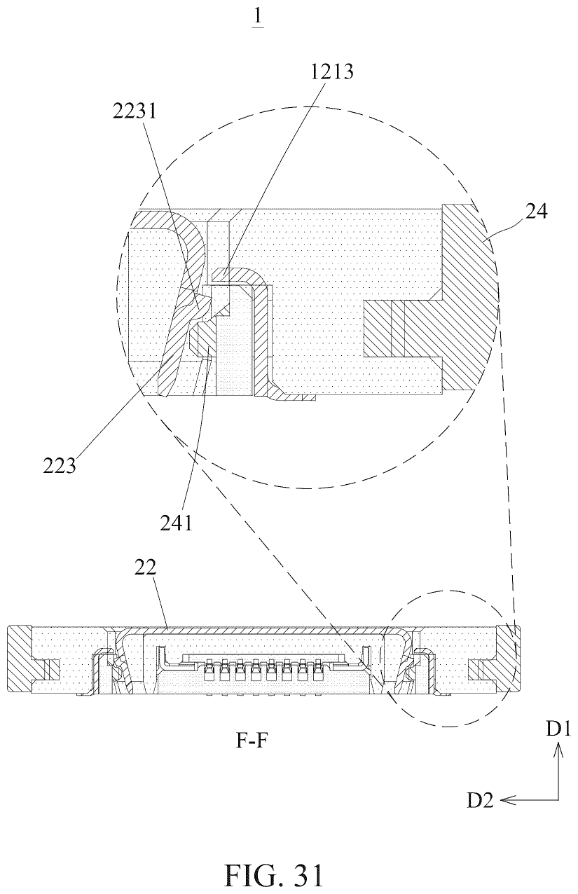

FIG. 30 is a top view of the easy-lock connector assembly 1 in an unlocked state according to the second embodiment, and FIG. 31 is a sectional view taken along the line FF in FIG. 30. As shown in FIG. 31, the L-shaped locking arm 223 is pushed inward in the second direction D2 by the rail portions 241 of the operated member 24 so that the latch portion 2231 of the L-shaped locking arm 223 is disengaged from the stopper portion 1213. At this time, the easy-lock connector assembly 1 is in an unlocked state, allowing the plug connector 20 to be removed from the receptacle connector 10.

The easy-lock connector assembly according to the present invention indeed has the advantages of low profile and good operability. In addition, the easy-lock connector assembly according to the present invention is particularly suitable for use in a compact or thin electronic machine. Additionally, the easy-lock connector assembly according to the present invention is also suitable for automated assembly of a flat connection object and board-mount connector.

While this invention has been described in reference to a preferred embodiment, it should be understood that numerous changes and modifications could be made within the scope of the inventive concepts described. Accordingly, it is intended that the invention not be limited to the disclosed embodiment, but that it have the full scope permitted by the language of the following claims.

What is claimed is:

1. An easy-lock connector assembly comprising a first connector and a second connector which is matable in a first direction;
wherein the first connector comprises:
a first insulating housing, having an accommodation space, wherein the second connector is to be inserted into the accommodation space in the first direction in such a manner that at least a portion of the second connector is received in the accommodation space;
a plurality of contacts held by the first insulating housing, the plurality of contacts being arranged in a second direction perpendicular to the first direction, each contact including a contact portion extending into the accommodation space and a connection terminal portion opposite to the contact portion; and
a first metal shell covering a portion of the first insulating housing, the first metal shell having two first engagement portions opposite to each other in the second direction;
wherein the second connector comprises:
a second insulating housing;
a second metal shell covering a portion of the second insulating housing, the second metal shell having two locking arms at two opposite sides in the second direction, each locking arm being oriented in the first direction, each locking arm being movable in the second direction between a latched position and an unlatched position and normally biased to the latched position, each locking arm having a second engagement portion such that when the second connector is mated with the first connector, the second engagement portion is engaged with a respective one of the two first engagement portions, preventing the second connector from being detached from the first connector; and
two operated members which are held by the second insulating housing in such a manner that the two operated members are movable in the second direction, each operated member being configured to push a respective one of the locking arms in the second direction, such that by operating the two operated members, the two locking arms are biased away from the latched position in the second direction, allowing the second connector to be removed from the first connector.

2. The easy-lock connector assembly of claim 1, wherein the second insulating housing has two guide posts formed on a bottom surface thereof and extending in the first direction, the guide posts being provided for guiding insertion of the second connector into the accommodation space during a process of mating the second connector with the first connector.

3. The easy-lock connector assembly of claim 2, wherein each guide post has a chamfered end.

4. The easy-lock connector assembly of claim 2, wherein the first insulating housing has two guide post holes for respectively receiving the two guide posts.

5. The easy-lock connector assembly of claim 1, wherein each locking arm is partially sheltered by a respective one of the guide post.

6. The easy-lock connector assembly of claim 1, wherein each locking arm is U-shaped.

7. The easy-lock connector assembly of claim 1, wherein each locking arm is L-shaped.

8. The easy-lock connector assembly of claim 1, wherein the second metal shell comprises an upper shell and a lower shell, the upper shell is disposed on an upper side of the second insulating housing, and the lower shell is disposed on a lower side of the second insulating housing; the second connector further comprises a flat connection object including a head portion and a plurality of electrode portions formed on the head portion, wherein the head portion of the flat connection object is accommodated in a space defined by the second insulating housing and the lower shell, and the plurality of electrode portions are exposed from the lower shell such that when the second connector is mated with the first connector, the plurality of electrode portions are brought into electrical contact with the plurality of contacts of the first connector respectively.

9. The easy-lock connector assembly of claim 1, wherein the two operated members are respectively disposed at two end portions of the second insulating housing in the second direction, each operated member comprises a body portion and a rail portion extending from the body portion in the second direction, wherein each of the two end portions of the second insulating housing is formed with a guide channel configured to receive the rail portion.

10. The easy-lock connector assembly of claim 9, wherein the rail portion has a protrusion configured to prevent the rail portion from being detached from the guide channel.
